(19) United States
(12) Patent Application Publication
(10) Pub. No.: US 2006/0068190 A1
(43) Pub. Date: Mar. 30, 2006

(54) Electronic devices with molecular sieve layers

(75) Inventors: Michael D. Goodner, Hillsboro, OR (US); Michael L. McSwiney, Scappoose, OR (US); Grant M. Kloster, Lake Oswego, OR (US); Sadasivan Shankar, Cupertino, CA (US); Michael G. Haverty, Mountain View, CA (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 10/956,794

(22) Filed: Sep. 30, 2004

(51) Int. Cl. B32B 3/06; B32B 15/04; B32B 19/00

(52) U.S. Cl. 428/307.3; 428/469; 428/701; 428/702; 427/345

(57) ABSTRACT

An electronic device that includes a molecular sieve layer is described herein. The molecular sieve layer may be used as a high mechanical strength, low dielectric constant insulating layer.

### BACKGROUND OF THE INVENTION

1. Field of the Invention

The present invention relates to, but is not limited to, electronic devices, and, in particular, to the field of electronic device dielectrics.

2. Description of Related Art

As electronic devices such as semiconductor devices continue to shrink, insulating materials with low dielectric constants (e.g., low k materials) are needed to reduce resistance-capacitance (RC) delay and cross talk between, for example, conductive interconnects. Typically these insulating materials are used to form one or more dielectric layers (sometimes referred to as interlayer dielectrics or ILDs) on top of a die or wafer substrate such as a substrate made of ceramic or silicon based material. Ideally these insulating materials will have low dielectric constant values and high mechanical properties (e.g., high modulus). Unfortunately materials that have low dielectric constant values will often have relatively poor mechanical properties while materials that have good mechanical properties will often have relatively high dielectric constant values.

Zeolites are a class of compounds having highly ordered porous structures. Typically the pores have diameters less than 2 nanometers (nm), and most zeolites have pores with diameters less than 1 nm. Because of their ordered nature, zeolites have significantly higher mechanical strength than porous silicon oxide based materials such as porous SiO₂, porous fluorinated silica glass (also referred to as SiOF or FSG), and porous organosilicate glass (OSG, also referred to as carbon-doped oxide or CDO). Zeolites typically comprise of silicon (Si), oxygen (O) and in some instances, other elements such as aluminum (Al). The use of a specific type of zeolite called silicalite for forming insulation layers in electronic devices is known. For example, U.S. Pat. No. 6,630,696 to Yan et al., describes an insulation material comprising of a pure silica MFI zeolite (note that the “MFI” designation is a three-letter code used to describe a particular type of zeolite framework or structure) known as silicalite. Depending upon the deposition techniques used, such materials have a dielectric constant value of less than 3.3 and bulk modulus values of 30 to 40 GPa.

Pure silica zeolites, which typically comprises of silicon and oxygen, as well as other zeolites (for example those that contain aluminum atoms), belong to a more general class of materials called molecular sieves. Molecular sieves, like zeolites, are materials that have structures (i.e., framework) which tend to be highly organized and porous. These molecular sieve structures will generally contain multiple tetrahedral sites. Tetrahedral sites are locations within the molecular framework where an atom may form four bonds. Zeolites are molecular sieves having silicon and aluminum atoms located at these tetrahedral sites. A pure silica zeolite will only contain silicon atoms at the tetrahedral sites.

A number of zeolite or molecular sieve frameworks have been identified over the years. The specific framework associated with a zeolite or molecular sieve will often depend on several factors including, for example, the chemical makeup of the zeolite or molecular sieve. Currently a number of distinct frameworks have been identified. The Structure Commission of the International Zeolite Association assigns three-letter codes to each framework topology such as, for example, ABW, MFI, FAU, MTW and the like.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates various classes of molecular sieves;

FIG. 2 illustrates an exemplary framework unit of a molecular sieve that comprises tetrahedral sites;

FIG. 3 illustrates examples of trivalent, tetravalent, and pentavalent materials;

FIGS. 4A and 4B illustrate simulation results when silicon or aluminum atoms are replaced with various materials in a zeolite framework; and

FIG. 5 is a block diagram of an example system, according to some embodiments of the invention.

### DESCRIPTION

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

The following description includes terms such as on, onto, on top and the like, that are used for descriptive purposes only and are not to be construed as limiting. That is, these terms are terms that are relative only to a point of reference and are not meant to be interpreted as limitations but are instead, included in the following description to facilitate understanding of the various aspects of the invention.

According to various embodiments, dielectric layers of electronic devices formed with materials having low dielectric constant values and high mechanical (high modulus) properties are provided. An electronic device may be, for example, a central processing unit, a graphical co-processor, a digital signal processor, volatile memory, input/output device, chipset input/output hub, memory controller, or other electronic devices. These electronic devices may be in the form of a die or wafer that may include a semiconductor substrate. As described previously, it is known to form dielectric layers of electronic devices using pure silica zeolites (e.g., those containing only silicon/oxygen atoms in the zeolite framework). However, in some embodiments, alternative materials may be used to form dielectric layers having similar or even better dielectric and/or mechanical properties than those of pure silica zeolites.

According to various embodiments of the invention, dielectric layers of electronic devices may be formed with molecular sieves other than pure silica zeolites. For the embodiments, the molecular sieves may comprise of atoms other than Silicon (Si), Aluminum (Al) and Oxygen (O) atoms such as Germanium (Ge), Titanium (Ti), Manganese (Mn), Gallium (Ga), Boron (B), Phosphorus (P), Arsenic (As), and Antimony (Sb). In various embodiments, the molecular sieves' framework may include tetrahedral sites that may be occupied by these atoms. In some embodiments, the molecular sieves may have a dielectric constant of less than about 3.0 and have a bulk modulus of greater than about 30 GPa.

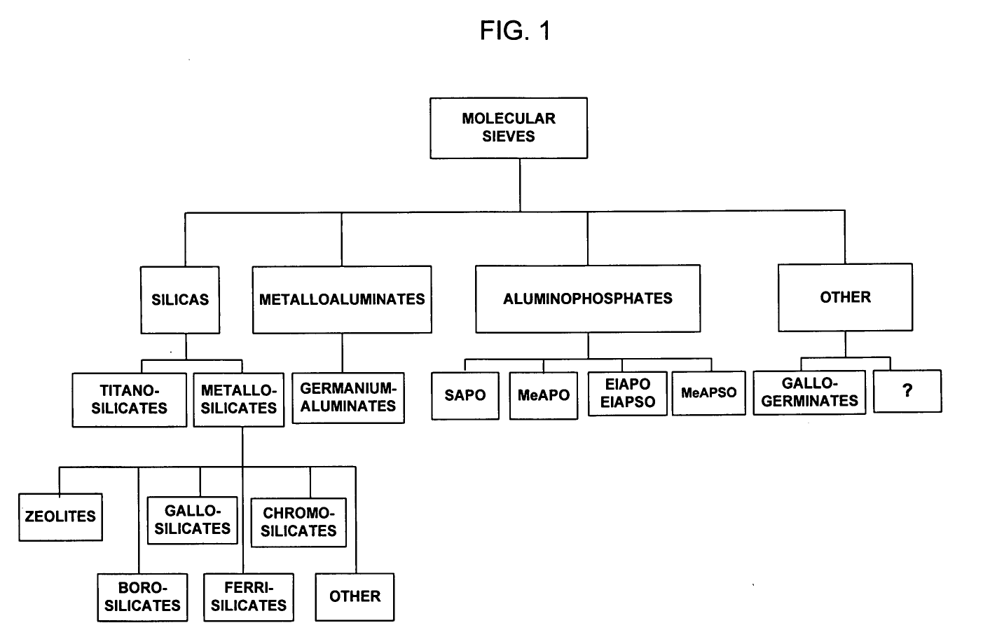

Referring now to FIG. 1, wherein various groups of molecular sieves including zeolites are depicted. Under the broad umbrella of molecular sieves are at least three classes of molecular sieves including, for example, silicas, metalloaluminates, and aluminophosphates. Under the silicas group are the zeolites, which are based on either silica (SiO2) or aluminosilicate (AlxSi1-xO2 where 0<x<1). On the other hand, other molecular sieves may include other atoms other than Si, Al, and O in their framework. For example, some of the other molecular sieves may be formed by replacing some of the Si and/or Al atoms in a zeolite framework structure with other atoms such as metal atoms other than Al. These would include, for example, gallosilicates, chromosilicates, borosilicates, and the like. In other instances, molecular sieves may have frameworks based primarily on aluminum/phosphate atoms (e.g., AlPO₄ or AlPO) or aluminum/phosphate/silicon atoms (e.g., SiAlPO or SAPO, SiₓAl₁₋ₓP₁₋ₓO₂ where 0<x<1) such as aluminophosphates.

A defining feature of zeolites and molecular sieves are that their frameworks are made up of tetrahedral sites or 4-connected networks of atoms. That is, tetrahedral sites are sites generally found throughout a molecular sieve framework where the atom that occupies those sites tend to form four bonds. The linking of various Si, Al, O, and/or other atoms in a molecular sieve framework structure may result in the formation of linked cages, cavities or channels. Depending on the chemical composition of the molecular sieve, pentavalent, tetravalent and/or trivalent atoms that may be located at these tetrahedral sites are located throughout a molecular sieve framework.

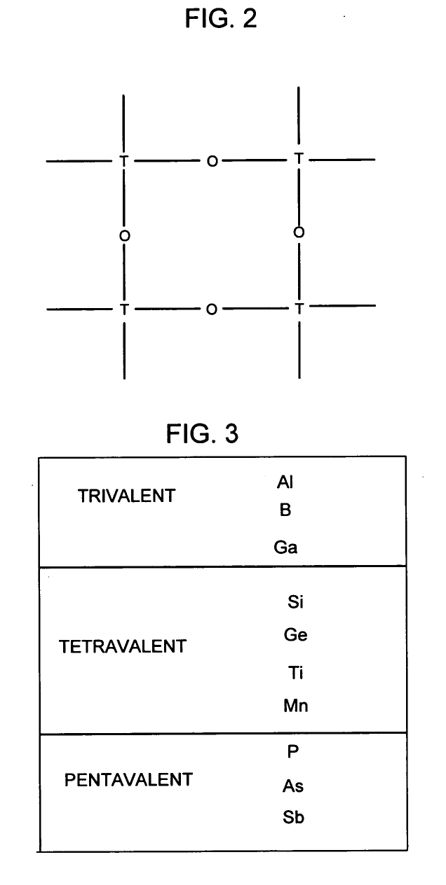

FIG. 2 depicts the smallest framework unit of an example molecular sieve in two-dimensions. In this example, the T's represents tetrahedral sites where, for example, in the case of zeolites, silicon and/or aluminum atoms may reside while the O's represents oxygen atoms. Surrounding this basic framework unit may be other basic framework units that may be linked to this unit.

In some molecular sieves, only tetravalent atoms will be located at the tetrahedral sites. For example, in the case of pure silica zeolites, only Si atoms, which are tetravalent atoms, are located at these sites. Other molecular sieves may have tetravalent atoms other than Si atoms occupying at least some of the tetrahedral sites.

In some molecular sieves, a combination of tetravalent and nontetravalent atoms may occupy the tetrahedral sites. Such structures, however, are naturally electrically imbalanced. In order to compensate for this imbalance, counterions may be included within the framework. For example, aluminosilicate zeolites have either Si or Al atoms occupying the tetrahedral sites. An Al atom, however, is a trivalent atom and, therefore, only has three valence electrons whereas Si is a tetravalent atom having four valence electrons. To form four bonds, the Al atom may acquire a fourth valence electron, thereby causing an electronic imbalance (a negative, minus one charge on the Al atom). Therefore, in order to compensate for the electron rich Al atoms, molecular sieves or zeolites containing Al in their frameworks typically must also include counterions such as alkali metals like Na+ or K+, or alkaline earth metals, such as Ca2+ or Ba2+. Unfortunately, molecular sieves that incorporate counterions may have certain drawbacks. For example, when a molecular sieve incorporates counterions, the inclusion of the counterions means that the molecular sieve will be somewhat hydrophilic and, thus, their dielectric constant values may be higher than those that employ only tetravalent atoms such as pure silica zeolite (SiO₂) due to water absorption. Molecular sieves containing counterions may also have higher electrical leakage currents, since the counterions are mobile and can conduct electricity through the layer.

In other types of molecular sieves, at least two different types of nontetravalent atoms, such as a pentavalent atom and a trivalent atom, may occupy tetrahedral sites in an alternating manner. That is, in some molecular sieve frameworks, if a pentavalent atom occupies a tetrahedral site then a “balancing” or “counter” atom such as a trivalent atom may occupy an adjacent tetrahedral site in order to maintain electrical neutrality. These molecular sieves may show a slight tendency to be hydrophilic although not as strongly as those molecular sieves that incorporate counterions such as those described above. Therefore, the dielectric constant values for the molecular atoms that incorporate balancing or counter atoms may be slightly higher than those molecular sieves that incorporate only tetravalent atoms. The mechanical properties of these pentavalent/trivalent combination molecular sieves may, however, still be relatively high. Additionally, since no mobile counterions are present in these molecular sieves, they may not be prone to high electric leakage currents.

In various embodiments, molecular sieves having trivalent, tetravalent (other than Si), and/or pentavalent atoms may be used to form dielectric layers in electronic devices. For the embodiments, such molecular sieves may have good mechanical and/or dielectric properties. In various embodiments, the trivalent, tetravalent (other than Si), and/or pentavalent atoms may occupy tetrahedral sites within the molecular sieve frameworks.

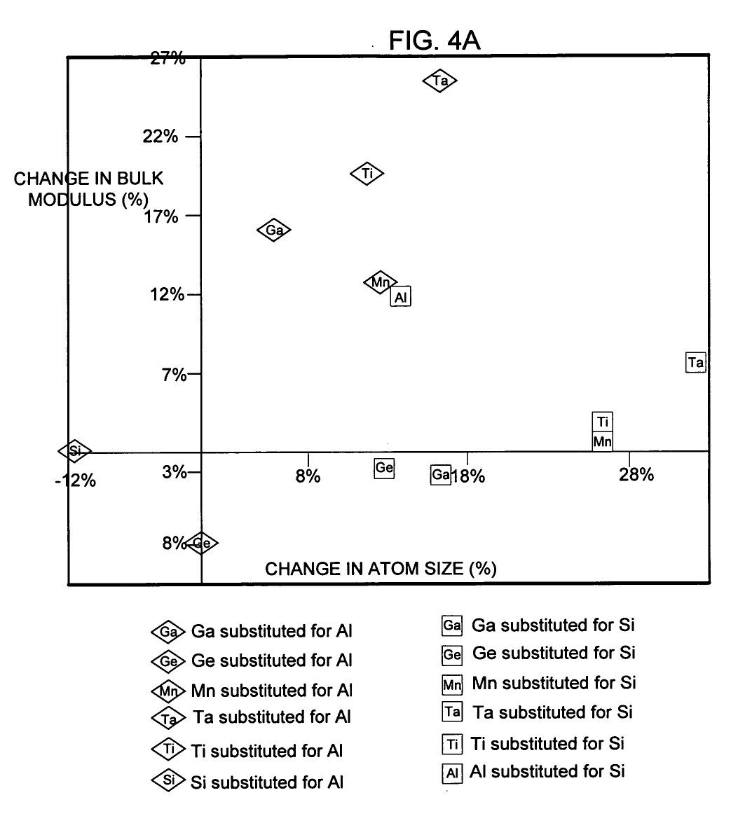

Referring now to FIG. 3, wherein a chart showing various atoms that may be classified as trivalent, tetravalent and pentavalent, is depicted. Note that this list is not exhaustive, but is representative of those atoms found in molecular sieve materials disclosed in the public domain. By incorporating various combinations of these trivalent, tetravalent and/or pentavalent atoms into a molecular sieve framework, electrical neutrality may be maintained without, for example, the addition of counterions into the framework. As a result, the molecular sieves may thus retain low dielectric and leakage current properties while having relatively high mechanical properties. These combinations include, in some embodiments, a combination of tetravalent atoms (e.g., Si, Ge, Ti, and Mn) that may occupy tetrahedral sites. In other embodiments, a combination of a trivalent (e.g., Al, P, and Ga) and a pentavalent (e.g., P, As, and Sb) atoms may occupy tetrahedral sites. For these embodiments, the trivalent and pentavalent atoms may be arranged in alternating fashion such that a pentavalent atom is always located at a tetrahedral site that is adjacent to a tetrahedral site occupied by a trivalent atom. In yet other embodiments, a combination of pentavalent, tetravalent, and trivalent atoms may occupy tetrahedral sites, with the pentavalent and trivalent atoms occupying adjacent tetrahedral sites.

According to various embodiments of the invention, molecular sieves containing tetravalent atoms other than Si atoms may be used to form one or more dielectric layers of electronic devices. For the embodiments, the nonsilicon tetravalent atoms may occupy tetrahedral sites within the framework of the molecular sieves. In various embodiments, the tetravalent atoms may be Ge, Ti, and Mn. According to these embodiments, by replacing one or more of the Si and/or Al atoms in a, for example, a pure silica (SiO₂) zeolite framework, a variety of molecular sieves having low dielectric constant and high modulus values may be realized. Such molecular sieves may have certain desirable properties, which may make them desirable materials for forming dielectric layers in electronic device according to various embodiments. For example, in some embodiments, molecular sieves having the formulas GeₓSi₁₋ₓO₂, MnₓSi₁₋ₓO₂, TiₓSi₁₋ₓO₂ (where 0<x<1) may be used to form dielectric layers of electronic devices.

In various embodiments, molecular sieves containing both pentavalent atoms, such as Phosphorus (P), and trivalent atoms, such as Aluminum (Al), may be used to form one or more dielectric layers in electronic devices. In some embodiments, the pentavalent/trivalent molecular sieves may be formed by inserting pairs of Al and P atoms at adjacent tetrahedral sites into the framework structure of a pure silica zeolite. In doing so, electrical neutrality may be maintained without counterions since the positive charge on the pentavalent atoms may compensate for the negative charge on the pentavalent atoms in the framework structure. As a result, the tendency of the framework to become hydrophilic may be curtailed and the dielectric constant values and leakage currents of the molecular sieves may be kept low.

In some embodiments, one or more dielectric layers of an electronic device may be formed with neutral pentavalent/trivalent molecular sieves such as molecular sieves having the formulas AlPO₄ and Si₁₋ₓAl_{x/2}P_{x/2}O₂, wherein 0<x<1. In other embodiments, other pentavalent/trivalent molecular sieves such as AlPO and SAPO (Silicon-Aluminum-phosphate-oxygen), gallophophates, galloarsenates, and the like, may be used to form the dielectric layers.

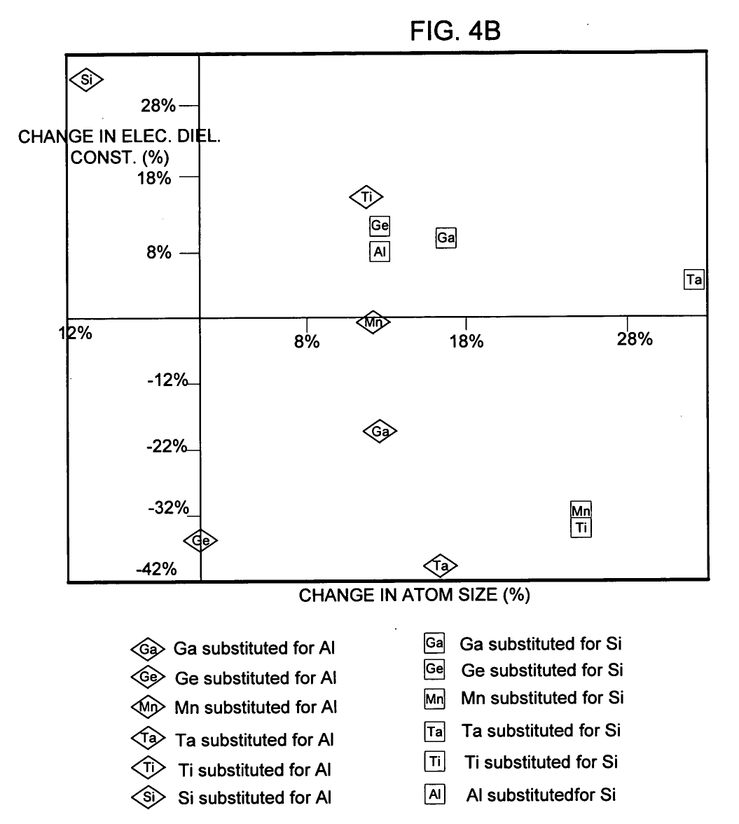

Referring now to FIGS. 4A and 4B, wherein simulation results when Si or Al atoms of an aluminosilicate zeolite FAU framework structure were replaced with various metals, are depicted. In particular, FIG. 4A shows percentage increase or decrease in the bulk modules when 4 percent of the Si or Al atoms in the aluminosilicate zeolite framework were replaced by Ga, Ge, Mn, Ta, Ti, Si, or Al atoms. Note that most of the substitutions resulted in bulk modulus values remaining essentially the same or increasing in value while a few of the substitutions resulted in slightly lower bulk modulus values. In contrast to FIG. 4A, FIG. 4B shows percentage increase or decrease in the dielectric constant values when 4 percent of the Si or Al atoms in the aluminosilicate zeolite framework were replaced by Ga, Ge, Mn, Ta, Ti, Si, or Al atoms. Here, some of the substitutions resulted in the dielectric constant values essentially remaining the same or decreasing while some of the substitutions resulted in higher dielectric constant values. Note further that when Mn and Ti replaced Si atoms, an approximately 30 percent reduction in the electronic portion of the dielectric constant was obtained while showing a slight increase in bulk modulus. Similarly, when Ge atoms replaced Al atoms in the framework, a greater than 30 percent decrease in dielectric constant value was realized while the bulk modulus was reduced by about 8 percent. As can be seen in FIGS. 4A and 4B, in some cases, bulk modulus values were increased by replacing Si or Al atoms with one of the substitute materials while in other cases, lower dielectric constant values were obtained when substituting the Si or Al atoms with the substitute materials. It should be noted that while an aluminosilicate zeolite may not be appropriate in practice due to the presence of mobile counterions (leading to water uptake and electrical leakage currents), the modulus and dry dielectric constant characterized in FIGS. 4A and 4B are similar to those of pure silica zeolites and thus applicable to those molecular sieve materials that may not have mobile counterions.

According to various embodiments, at least two techniques, in situ formation and a priori formation using, for example, a spin-on technique, may be employed to form the molecular sieve layers described above. Regardless of the formation technique used, an electronic device that comprises of a substrate is initially provided. In various embodiments, the electronic device may be in the form of a die or wafer. For these embodiments, the substrate may be a semiconductor substrate such as those made of ceramic or glass material and may further include one or more dielectric layers. Although the following descriptions for in situ and a priori formation of molecular sieve layers are for pure silica zeolite layer formation, the techniques may be used to form the novel molecular sieve layers described above by replacing the precursor (e.g., TEOS) used to form the pure silica zeolite layer with an appropriate precursor.

In various embodiments, the molecular sieves may be synthesized directly on a substrate of an electronic device in situ. For the embodiments, an initial precursor solution may be provided that includes a precursor, which contains the basic molecular sieve source, and a templating agent (a type of structure directing agent; SDA). The templating agent may be removed either upon film (i.e., molecular sieve layer) formation (“normal” integration flow for porous dielectrics) or after other processing steps have been completed.

According to some embodiments, the in situ process involves initially forming a thin (controlled in the range 250-500 nm) silicalite film on a substrate, in this case, a silicon wafer. In various embodiments, a coating of silicon nitride and oxide may cover the wafer. The film may be prepared by in situ crystallization using a clear precursor solution with molar composition 0.32 TPAOH/TEOS/165H₂O (TPAOH is tetrapropylammonium hydroxide and TEOS is tetraethylorthosilicate). In these embodiments, the TPAOH is the templating agent and the TEOS is the precursor. Again, note that for the novel molecular sieve layers described above, other types of precursors and templating agents may be used. The specific type of precursor to be used may depend upon the specific molecular sieve layer to be formed as will be recognized by those skilled in the art. The wafer may be a cleanroom grade wafer and may be used without further cleaning. The wafer, in one embodiment having the dimensions 2 cm×2 cm, may be fixed in a Teflon®-lined Parr autoclave. A crystallization process may be performed on the film and may be carried out in a conventional oven at about 165° C. for about 2 hours. As-synthesized film samples may be rinsed with deionized water and blow-dried with air. The template agent may then be removed by calcination at 450° C. for 2 hours under air. Note that in other embodiments, the specific temperatures, concentrations, and the like, that may be employed may vary depending upon the specific molecular sieve being synthesized.

In various embodiments, the use of in situ process for forming the molecular sieve dielectric layer may have certain desirable benefits. For example, the final calcination process in the in situ process may be carried out after interconnect metallization processes (such as those in dual damascene schemes) are performed. Such an approach may assure additional mechanical robustness of the dielectric layer and may prevent roughness defects (by keeping the pores filled with the templating agent) from occurring during the metallization processes.

According to some embodiments, a molecular sieve layer may be formed on a substrate of an electronic device by a priori formation of molecular sieve crystals in a solution and spin coating the solution onto the substrate. The molecular sieve layer may then be formed by calcination of the spin coated film. For the embodiments, a molecular sieve precursor solution containing a templating agent, molecular sieve precursors, and an appropriate solvent may be initially prepared. The molar composition of the precursor solution may depend on the exact molecular sieve to be synthesized. After forming the precursor solution, a crystallization process may be performed when the precursor solution is loaded into a vessel, which is sealed, and heated to a temperature of from about 40° to about 100° C., although different temperatures may be used for different embodiments, depending on the exact type of molecular sieve being synthesized. The heating time may also vary, and in some embodiments may vary between 1 to 7 days. After heating, a solution containing a suspension of molecular sieve nanocrystals is produced. The nanocrystals may then be recovered by various means including, for example, ultracentrifugation. The nanocrystals may then be placed into a liquid such as ethanol or other appropriate dispersant, and placed on the substrate, which may be on a spin coater. The substrate may then be spun at a high rate of speed to form a highly uniform film on the substrate. A brief drying process may then be performed followed by a calcination process in order to remove any templating agent that may be remaining in the film. Note that in other embodiments, the specific temperatures, concentrations, and the like, that may be employed may vary depending upon the specific molecular sieve being synthesized.

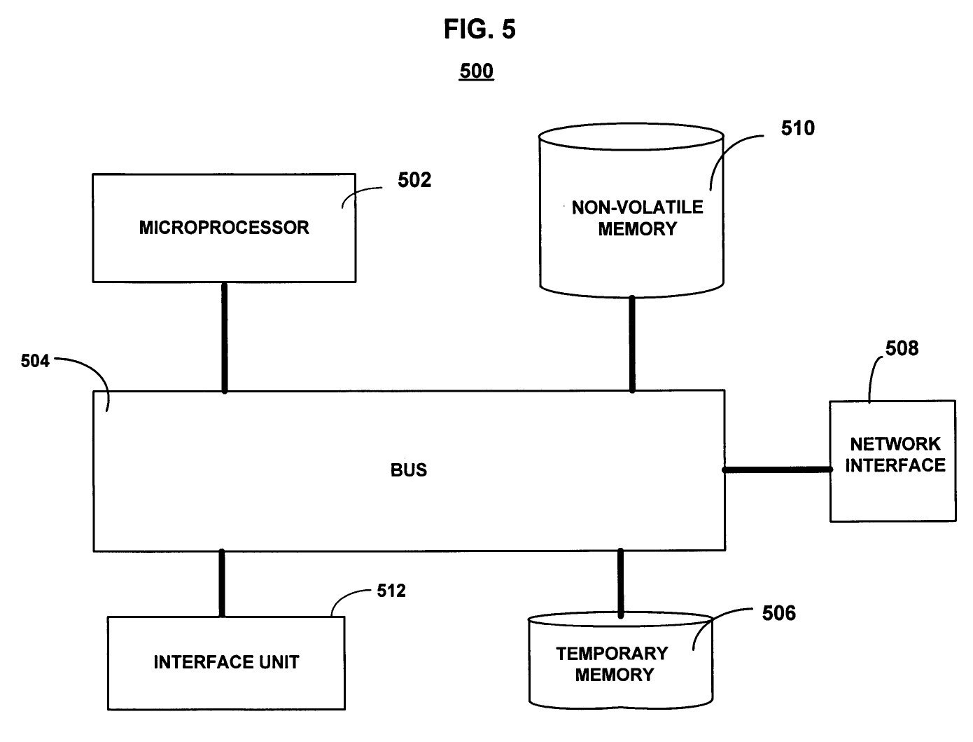

Referring now to FIG. 5, where a system 500 in accordance with some embodiments is shown. The system 500 includes a microprocessor 502 that may be coupled to a bus 504. The system 500 may further include temporary memory 506, a network interface 508, an optional nonvolatile memory 510 (such as a mass storage device) and an input/output (I/O) device interface unit 512. In some embodiments, the input/output device interface unit 512 may be adapted to interface a keyboard, a cursor control device, and/or other devices. One or more of the above enumerated elements, such as microprocessor 502, temporary memory 506, nonvolatile memory 510, and so forth, may include the novel molecular sieve layers described above.

Depending on the applications, the system 500 may include other components, including but not limited to chipsets, RF transceivers, mass storage (such as hard disk, compact disk (CD)), digital versatile disk (DVD), graphical or mathematic co-processors, and so forth.

One or more of the system components may be located on a single chip such as a system on chip (SOC). In various embodiments, the system 500 may be a personal digital assistant (PDA), a wireless mobile phone, a tablet computing device, a laptop computing device, a desktop computing device, a set-top box, an entertainment control unit, a digital camera, a digital video recorder, a media recorder, a media player, a CD player, a DVD player, a network server, or device of the like.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the embodiments of the present invention. Therefore, it is manifestly intended that this invention be limited only by the claims.

What is claimed is:

1. A die, comprising:
a substrate; and
a dielectric layer on top of the substrate, the dielectric layer comprises a molecular sieve, the molecular sieve comprising at least one atom selected from the group consisting of Ge, Ti, Mn, Ga, B, P, As, and Sb.

2. The die of claim 1, wherein said at least one atom is Ge.

3. The die of claim 1, wherein said at least one atom is Ti.

4. The die of claim 1, wherein said at least one atom is Mn.

5. The die of claim 1, wherein said at least one atom is Ga.

6. The die of claim 1, wherein said at least one atom is B.

7. The die of claim 1, wherein said at least one atom is P.

8. The die of claim 7, wherein said molecular sieve further comprises an atom selected from the group consisting of Al, B, and Ga.

9. The die of claim 1, wherein said at least one atom is As.

10. The die of claim 9, wherein said molecular sieve further comprises an atom selected from the group consisting of Al, B, and Ga.

11. The die of claim 1, wherein said at least one atom is Sb.

12. The die of claim 11, wherein said molecular sieve further comprises an atom selected from the group consisting of Al, B, and Ga.

13. The die of claim 1, wherein the molecular sieve having a chemical formula selected from the group consisting of GeₓSi₁₋ₓO₂, MnₓSi₁₋ₓO₂, and TiₓSi₁₋ₓO₂, wherein 0<x<1.

14. The die of claim 1, wherein the molecular sieve having a chemical formula selected from the group consisting of AlPO₄ and Si₁₋ₓAl_{x/2}P_{x/2}O₂, wherein 0<x<1.

15. A method, comprising:
providing a substrate; and
forming a molecular sieve layer on top of the substrate, the molecular sieve layer comprising of at least one atom selected from the group consisting of Ge, Ti, Mn, Ga, B, P, As and Sb.

16. The method of claim 15, wherein said forming comprises forming the molecular sieve layer by a method selected from the group consisting of in situ formation and a priori formation.

17. The method of claim 15, wherein said forming comprises adding a templating agent to a precursor in water to form a precursor solution.

18. The method of claim 17, wherein said forming further comprises depositing the precursor solution onto the substrate.

19. The method of claim 17, wherein said forming further comprises crystallizing the precursor solution and recovering nanocrystals from the precursor solution.

20. The method of claim 19, wherein said forming further comprises placing the recovered nanocrystals into a dispersant and depositing the resulting dispersant onto the substrate.

21. A system, comprising:
a die, including:
a substrate; and
a dielectric layer on top of the substrate, the dielectric layer comprises a molecular sieve, the molecular sieve comprising of at least one atom selected from the group consisting of Ge, Ti, Mn, Ga, B, P, As, and Sb;
a bus coupled to the die; and
a mass storage coupled to the bus.

22. The system of claim 21, wherein the molecular sieve having a chemical formula selected from the group consisting of GeₓSi₁₋ₓO₂, MnₓSi₁₋ₓO₂, and TiₓSi₁₋ₓO₂, wherein 0<x<1.

23. The system of claim 21, wherein the molecular sieve having a chemical formula selected from the group consisting of AlPO₄ and Si₁₋ₓAl_{x/2}P_{x/2}O₂, wherein 0<x<1.

24. The system of claim 21, wherein the system further comprises an input/output device interface unit adapted to interface at least a selected one of a keyboard and a cursor control device.

25. The system of claim 21, wherein the system is a selected one of a set-top box, a digital camera, a CD player, or a DVD player.
